(19) United States
(12) Patent Application Publication
(10) Pub. No.: US 2012/0169612 A1
(43) Pub. Date: Jul. 5, 2012

(54) METHOD AND APPARATUS FOR A TOUCH AND NUDGE INTERFACE

(75) Inventors: Rachid Alameh, Crystal Lake, IL (US); Roger Scheer, Beach Park, IL (US); Robert Zurek, Antioch, IL (US)

(73) Assignee: Motorola, Inc., Schaumburg, IL (US)

(21) Appl. No.: 12/982,428

(22) Filed: Dec. 30, 2010

(51) Int. Cl. G06F 3/041

(52) U.S. Cl. 345/173

(57) ABSTRACT

An apparatus can include an apparatus housing, a substantially planar touch surface coupled to the apparatus housing, and a plurality of oblique sensors coupled to the touch surface. Each oblique sensor of the plurality of oblique sensors can have a sensor surface substantially oblique to the touch surface. The plurality of oblique sensors can detect a touch force parallel to the touch surface.

### BACKGROUND

1. Field

The present disclosure is directed to a method and apparatus for a touch and nudge interface. More particularly, the present disclosure is directed to detecting touch and nudge actions on a touch surface.

2. Introduction

Presently, electronic devices used in today's society include mobile phones, personal digital assistants, portable computers, and various other electronic devices. Many devices use touch screens or other touch surfaces for a user interface. For example, touch screens allow a user to see a desired input icon or other element on the screen and touch the icon to activate an input. As another example, a touch surface on a laptop computer allows a user to control a pointing device on a screen. Some touch surfaces allow a user to slide a finger or stylus across the surface to perform an action. For example, a user can slid their finger to switch from one screen to a subsequent screen or to scroll items in a window.

Unfortunately, current touch surfaces only allow for tapping or sliding motions. They do not allow a user to keep a finger in one static location on the surface and nudge the finger in a direction to perform an action without substantially moving the finger. Thus, there is a need for a method and apparatus for a touch and nudge interface.

### BRIEF DESCRIPTION OF THE DRAWINGS

In order to describe the manner in which advantages and features of the disclosure can be obtained, various embodiments will be illustrated in the appended drawings. Understanding that these drawings depict only typical embodiments of the disclosure and do not limit its scope, the disclosure will be described and explained with additional specificity and detail through the use of the drawings in which:

FIG. 1 is an example illustration of an apparatus according to a possible embodiment;

FIG. 2 is an example illustration of a device, such as the apparatus according to a possible embodiment;

FIG. 3 is an example illustration of a sensing system according to a possible embodiment;

FIG. 4 is an example illustration of the force versus time for each sensor of a touch surface and three sensor system according to a possible embodiment;

FIG. 5 is an example illustration of a nudge in a particular direction within a three sensor system according to a possible embodiment;

FIG. 6 is an example illustration of an x-axis and y-axis outputs in time graph according to a possible embodiment;

FIG. 7 is an example resultant vectors over time illustration for an x-axis and a y-axis according to a possible embodiment;

FIG. 8 is an example illustration of a ratio region for a normal numeric keypad according to a possible embodiment;

FIG. 9 is an example illustration of time response graph of a keypress event followed by a longer hold according to a possible embodiment;

FIG. 10 is an example illustration of a graph of reference levels according to a possible embodiment;

FIG. 11 is an example illustration of a system showing a relationship between finger placements according to a possible embodiment;

FIG. 12 is an example illustration of a graph showing a difference in the time signal between pressing at a point roughly equidistant between sensors according to a possible embodiment;

FIG. 13 is an example illustration of a graph showing a time signal for pressing at a point near one sensor, and nudging or rolling between the two points according to a possible embodiment;

FIG. 14 is an example illustration of system having truncated pyramids containing multiple trapezoidal sensor components beneath a touch surface according to a possible embodiment;

FIG. 15 is an example illustration of a pyramid structure system using FSR type resistive sensors on pyramid structures forming a ladder voltage network according to a possible embodiment;

FIG. 16 is an example illustration of pyramid interconnection scheme according to a possible embodiment; and

FIG. 17 is an example illustration of a graph of a voltage output of a network using orthogonal sensors according to a possible embodiment.

### DETAILED DESCRIPTION

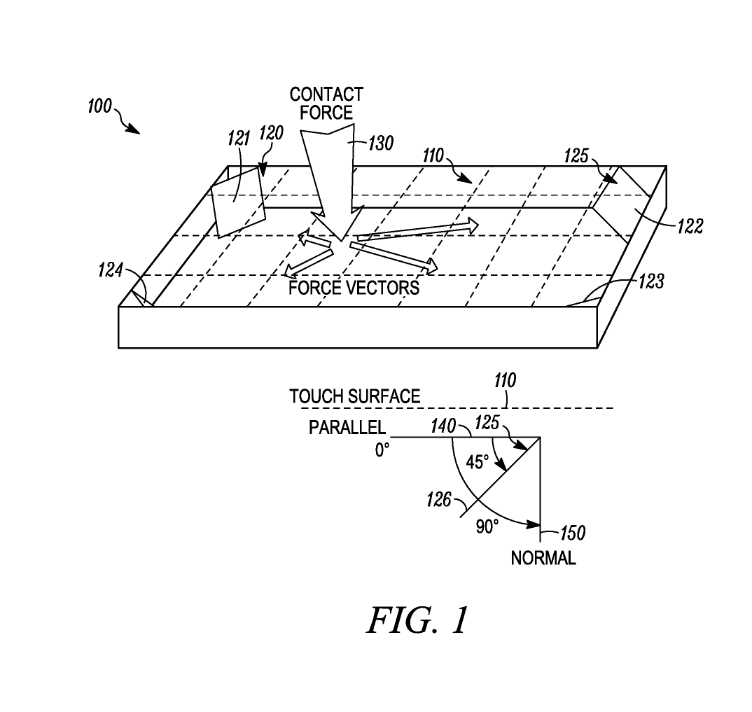

A method and apparatus for a touch and nudge interface is disclosed herein. FIG. 1 is an example illustration of an apparatus 100 according to one embodiment. The apparatus 100 and elements disclosed in the other embodiments can be included in an electronic device, such as a wireless telephone, a cellular telephone, a personal digital assistant, a pager, a personal computer, a selective call receiver, a game controller, a personal media player, a personal navigation device, or any other device that receives user input. The apparatus 100 can include a touch surface 110 and sensors 120 that can include sensors 121, 122, 123, and 124. The sensors 120 can be positioned below the touch surface 110 within a medium that transfers contact force 130 throughout the sensor area. For example, the contact force 130 can be applied using a finger, a stylus, or other device that can apply a contact force. Each sensor surface 125 can be oriented in an oblique position 126 between parallel 140 and normal 150 to the touch surface 110 to optimize the response of the sensors 120 for a particular media and configuration. The location of the contact force 130 can be determined by a ratio of forces on the sensing surfaces 125 located in each of four corners, four sides, or otherwise located in the apparatus 100. An optimal angle of an oblique sensor 121 to the touch surface can be different for each sensor surface within a sensing network, can be different between the four sensors 120 to favor certain press direction, or can be otherwise determined based on a desired implementation. For example, four sensors 120 can be oriented at 45 degrees from the touch surface 110. Calibration of the sensors 120 within this system can allow a processor to calculate the position of the contact force on the touch surface 110 by comparing the ratio of forces on each of the sensors 120.

The touch surface 110 can be rigid and can translate with user input. For example, the touch surface 110 can be an exterior panel of a device, any part of device front, back, or sides housing, can be a battery cover, can be a lens, or can be any other touch surface. Alternatively, the touch surface 110 can be soft and malleable while not exhibiting gross translation, but can rather exhibit compression and expansion, such as by using a rubber outer surface. In general both rigid and compressible surfaces can be coupled to sensors 120 whose sensing surfaces 125 can be oriented in planes that are not parallel to the touch surface 110.

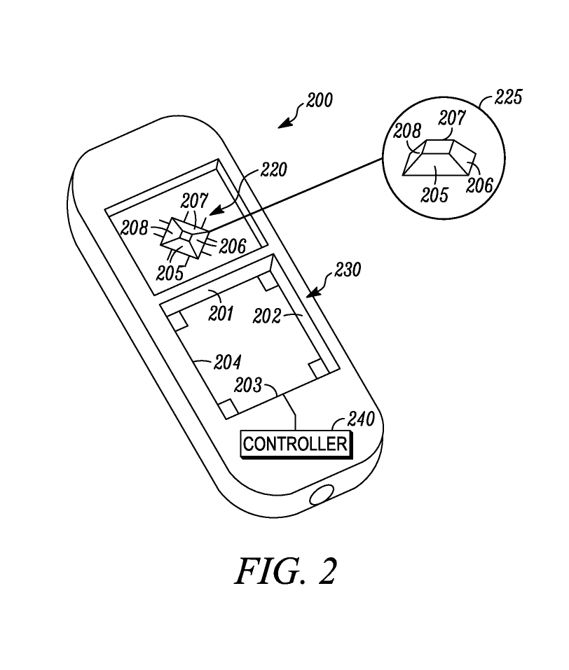

FIG. 2 is an example illustration of a device 200, such as the apparatus 100 according to one embodiment. The device 200 can include sensors 220 and/or sensors 230. The sensors 220 can include sensors 205-208 and the sensors 230 can include sensors 201-204. The sensors 220 can be configured in a set to work as a navigation button that a user can rock his finger over. The navigation button arrangement can work with the sensors 220 oriented on the surface of a truncated pyramid structure 225. The sensors 230 can be configured for an entire touch surface enabled for touch and nudge detection. The touch surface arrangement can work with the sensors 230 oriented on the edges of a trough bounding a surface.

The sensors 220, 230, or any other sensors disclosed herein can be coupled to a controller 240. The controller 240 can process sensor data to achieve a desired output using analog circuitry, using digital signal processing of time sampled data, or using any other useful processing method. The sensor signal that is processed can be an analog signal, such as a voltage, can be a digital quantity representing a potential, a capacitance charge, or a frequency, or can be any other sensor signal. For example, analog processing can be performed on a voltage output of Force Sensitive Resistor (FSR) type sensors. As another example, processing can be performed on a charge from a piezo-ceramic material, such as a piezoelectric transducer. A piezo-ceramic material can use an input that does not dissipate the charge of the piezo-ceramic material connected to the sensors with wiring that does not discharge the piezo-ceramic appreciably over time. Another example, processing can be performed on a signal frequency shift resulting from a capacitance change.

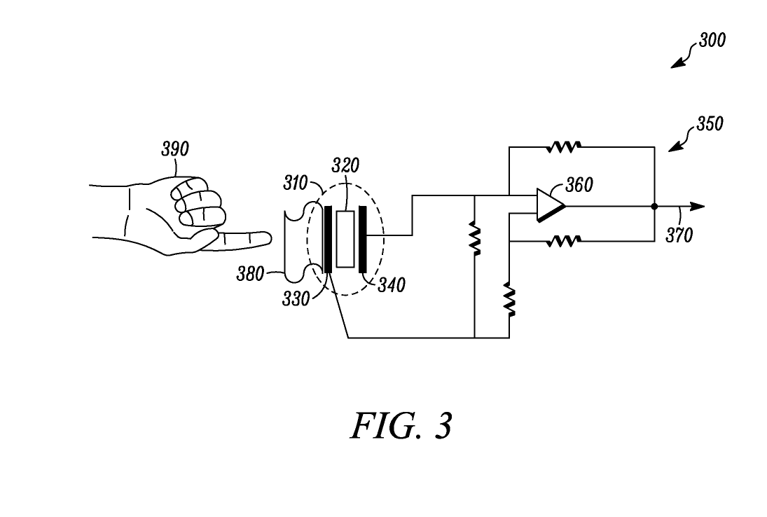

FIG. 3 is an example illustration of a sensing system 300. The system can include at least one capacitive sensor 310 and at least one analog circuit 350. The capacitive sensor 310 can include an elastomer 320 in between a moving plate 330 and a fixed plate 340. The analog circuit 350 can include an oscillator stage 360 and an oscillator output 370. The capacitive sensor 310 can produce an oscillation in the analog circuit 350, which can then be sampled at a time interval and used for further processing to determine manipulation of a device by a user 390. Processing can include quantifying the frequency of the oscillation. Any other form of converting the force sensitive capacitance to a voltage can work equally as well. The change in capacitance of the two plate system can create a change in the frequency of the circuit 350 in relation to the relative distance between the plates 330 and 340. The distance between the plates 330 and 340 can be allowed to change due to the elastomeric dielectric material 320 inserted between the plates 330 and 340. When the user 390 touches a device's surface 380, a force can be exerted on the moving plate 330 through the surface 380 material. This force can compress the elastomeric dielectric material 320 reducing the plate separation, and causing a change in capacitance of the sensor 310, which can result in a change in frequency of the oscillator 350. The capacitance formed by the two plates 330 and 340 with separation inversely proportional to a finger press. It can also be formed using a single metal plate and the user's finger can form the other plate with finger plate separation inversely proportional to the finger press. For this to work, the user's body can create some level of coupling to device ground.

The oscillator output 370 can be converted into a frequency value which can be a digital scalar value when an analog to digital converter is used or a rectification of the signal can produce a DC voltage level that can track pressure if analog circuitry is used. Embodiments can illustrate the application of the digital signal processing, although processing can be done both through signal processing of a scalar sensor output, or realized via an analog circuit.

The frequency output of the circuit 350 can be converted to a scalar number by means of a frequency counter function in a processor. Since the sensors 120 are not in the plane of the touch surface 110, a voltage or scalar number associated with a sensor output can have vector components that lay along an axis normal to the surface touch 110 and across the touch surface 110 when the sensors 120 are at some angle to the surface 110 other than 90 degrees. If the sensors are 90 degrees to the touch surface 110, in-plane nudges can be detected without detecting information that is perpendicular to the plane of the touch surface 110. Also, for a rubber skin touch surface, rubber deformation can still impact 90 degree orientated sensors due to rubber deforming in a 3D space. If the touch surface 110 is rigidly attached to the sensors 120, the sensors 120 can be at some angle to the touch surface 110 that is not 0 or 90 degrees, and the sensors can allow for discrimination between pressures or displacements that are both greater than and less than can equilibrium value. Thus, nudge information can be sensed across the entire touch surface 110 with two sensors whose included angle is 90 degrees from the touch plane. For example, sensors 201 and 202 or 205 and 206 can be used for this purpose. When two sensors are used, force oriented towards the touch surface 110 can be confounded with the force in one lateral direction unless the sensors are mounted 90 degrees to the touch surface 110 and orthogonal to one another. When mounting the sensors 90 degrees to the touch surface 110 and orthogonal to one another, there may be no measure of downward force exerted by a user.

The sensors 120 can be mounted in sets of four with opposing sensor planes forming parallel lines where they would intersect the touch surface if projected that far. Furthermore, neighboring sensors can provide simple calculation if the projected intersection of the sensors with the touch surface 110 are lines at right angles. For example, the sensors 205-208 can form a sensor set that can be used as a virtual joystick. As another example, sensors 201-204 can form a sensor set that can be used as a map-able touch surface with nudge and force detection capabilities. One configuration of the touch sensors 120 planes can have the sensor faces 125 all angled 45 degrees to the touch surface 110.

Depending on desired user interface control of a device, the sets of paired sensors can be processed in different ways. For example, a ratio of opposing sensors can be calculated to determine a position of a touch or nudge on the touch surface 110. In the case of a system where the output of a sensor is a value positively correlated to the pressure that is placed on that sensor, the processing to relate the user's input to nudge or position information can be simply indicated as the “up” sensor divided by the “down” sensor equals the up/down nudge magnitude and direction. “Up,” “down,” and other relational terms are used for their relative directional nature in one frame of reference for descriptive purposes and do not limit embodiments to particular directions. The resulting up/down nudge magnitude and direction ratio of 1 can indicate no nudge in the up/down orientation, a ratio greater that 1 can be an upward nudge of increasing magnitude, and a ratio less than 1 can be a nudge in the down direction. Likewise the same can apply for the right and left orientation. A diagonal nudge can have components in both the up/down, and right/left directions. For a capacitive sensor system that varies an oscillator frequency with change in capacitance (pressure), the system can become:

up_down output=[(c+1)−c*(upval/n)]/[(c+1)−c*(dnval/n)]

right_left output=[(c+1)−c*(rtval/n)]/[(c+1)−c*(ltval/n)]

Where:

c=an intercept constant; n=the at rest “no-press” output of the sensor; upval=the instantaneous output of the up sensor 201; dnval=the instantaneous output of the down sensor 203; rtval=the instantaneous output of the right sensor 202; and ltval=the instantaneous output of the left sensor 204.

The mapping of position on the surface can be obtained by having the center location have a ratio of 1 in both the up/down, and right/left orientations. Ratios increasingly greater than 1 in the up/down calculation can relate to increasing position up the touch surface 110. Ratios decreasingly less than 1 in the up/down calculation can relate to decreasing position down the touch surface 110. The same can follow for the right/left calculations where the ratios greater than 1 can relate to positions right of center and ratio values less than 1 can relate to positions left of center. In order to prevent a center “touch” location when there is no touch, this ratio method can be used to detect a position once a non-resting force is detected at one or more of the sensors. For example, it can be triggered by a calculated Z-force above a certain trigger level.

Nudge detection can be done in at least two ways. The first can be to look at a ratio of opposing sensors after a recalibration process to rule out the absolute position of the touch point. The other nudge case can be gotten from a difference of opposing sensors, which works best with the pyramid shaped sensor configuration 225. The implementation of this can be as simple as: the up sensor minus the down sensor equals the up/down nudge magnitude and direction (from the sign of the output). The total nudge vector can then be the calculated from the orthogonal values of the up/down nudge and the right/left nudge. For the capacitive sensor system that varies an oscillator frequency with change in capacitance (pressure), the system can become:

up_down output=[c−c*(upval/n)]−[c−c*(dnval/n)]

right_left output=[c−c*(rtval/n)]−[c−c*(ltval/n)]

Where:

c=an intercept constant; n=the at rest “no-press” output of the sensor; upval=the instantaneous output of the up sensor 207; dnval=the instantaneous output of the down sensor 205; rtval=the instantaneous output of the right sensor 206; and ltval=the instantaneous output of the left sensor 208.

In either the trough 230 or pyramid 220 case, the z-axis pressure level can be used to set a magnitude for the orientation vector for a push or nudge. This can be gotten via a simple summation of all of the sensors or through extracting the z-axis-only contribution of the signal via a mathematical combination of the summed and difference signals to determine the common signal exerted on all four sensors.

The angle or angle and magnitude of the orientation vector can be gotten from the x-axis and y-axis pressure differentials. In the case of the angle only, the angular sum of the x and y components can be normalized and then the magnitude vector can come from the multiplication of this signal by the z-magnitude. In the case of the both angle and magnitude coming from the x and y axis signals, the angular sum of the x and y components may not be normalized and the resulting in-plane magnitude can be the magnitude of the vector in the user interface. The difference between the way in which the user would interact with these two systems is where the vector only is obtained from the x and y information. The harder the user pushes down on the device, the larger the amplitude of the vector can be. In the case in which both the angle and magnitude are gotten from the x and y information, the harder a user pushes in the in-plane direction of the nudge, the higher the magnitude the vector can be. This case cancels out how hard a user actually pushes down on a device and only looks at the lateral or in-plane forces.

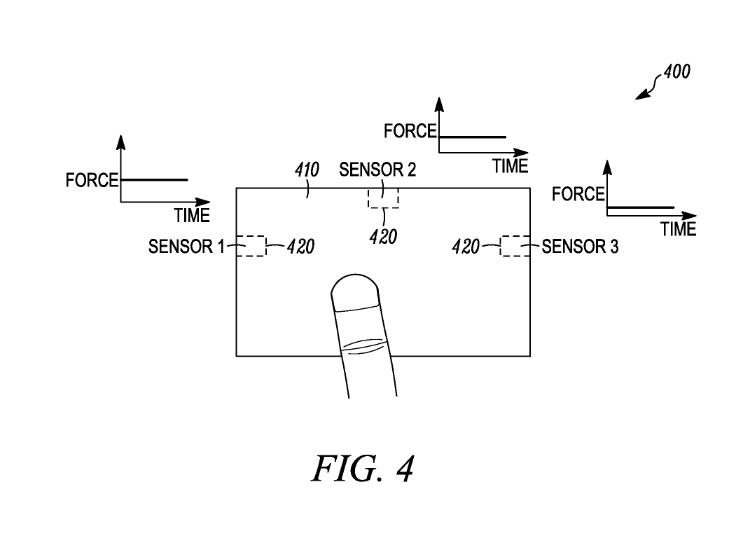

FIG. 4 is an example illustration of the force versus time for each sensor 420 of a touch surface and three sensor system 400 according to one embodiment. The system 400 can include a touch surface 410 and sensors 420. The touch surface and sensor system 400 can be calibrated to allow a processor to calculate the location of a contact force on the touch surface 410. The output of a sensor can be indicative of the force on the sensor. A singular touch, such as a keypad press, can provide a relatively constant force on all three sensors 420 over a short period of time. The ratio of forces between sensors 420 can be indicative of the relative distance of the contact force from each sensor.

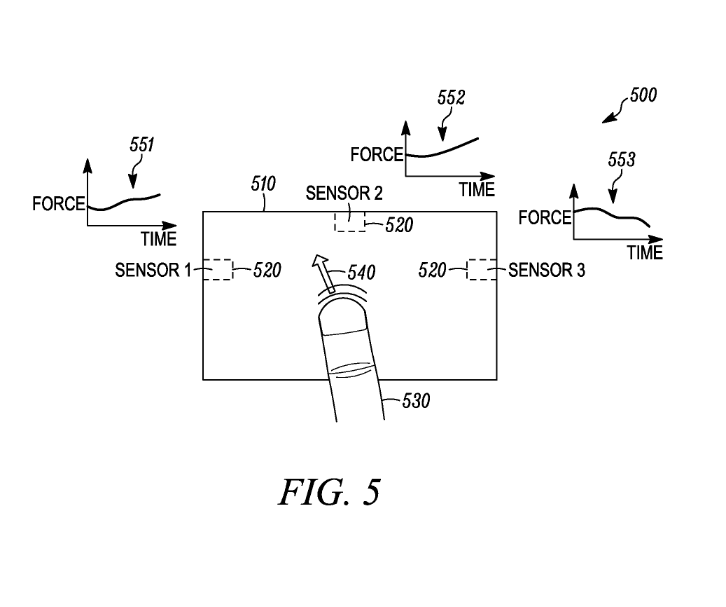

FIG. 5 is an example illustration of a nudge in a particular direction within a three sensor system 500. The system 500 can include a touch surface 510 and sensors 520. If a digit 530 or device exerting a contact force 540 on the touch pad is pushed towards a given direction without moving from the original place of contact, a nudge occurs that can create a force vector within the medium surrounding the sensors 520 and the force seen at each sensor can change accordingly. Typical force responses 551, 552, and 553 on each sensor are shown. A calibrated system can determine the magnitude and direction of the force vector created by the nudge. The response is similar to the response from allowing the digit 530 to slide across the touch surface 510 in the direction of the vector and mapping out the successive placement of the contact forces. Vector magnitude and direction sensing can be used to create a Navigation Key in a calibrated touch system. The Navigation Key function can also be moved and/or recalibrated to multiple positions on the touch surface 510 as the user desires or the underlying function or design requires. Vector magnitude-only sensing can be utilized along predefined directions to control increasing/decreasing type functions such as volume control.

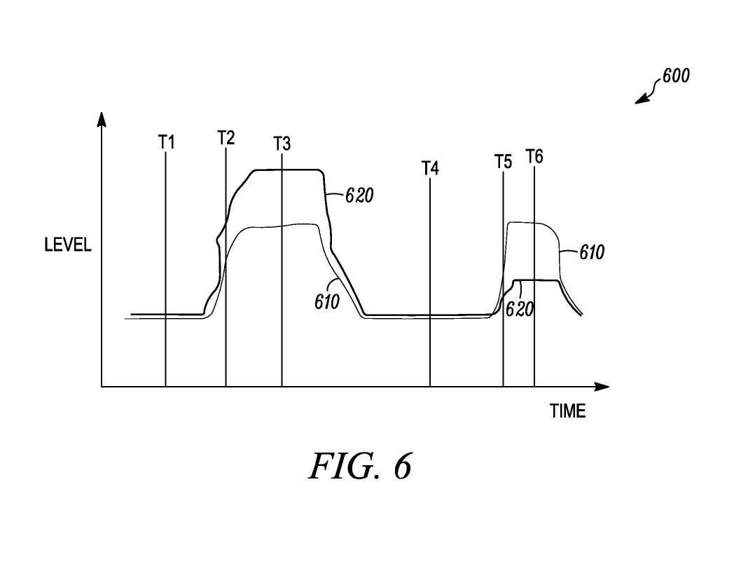

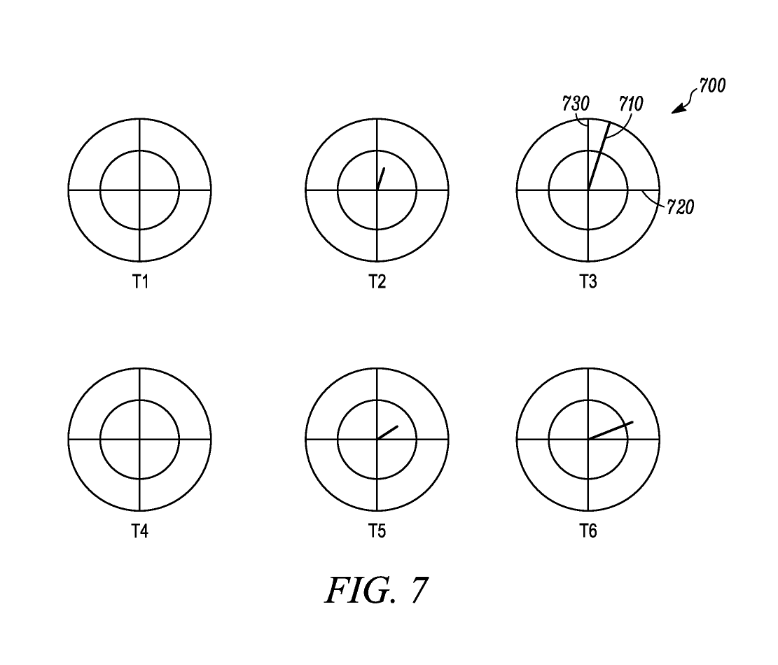

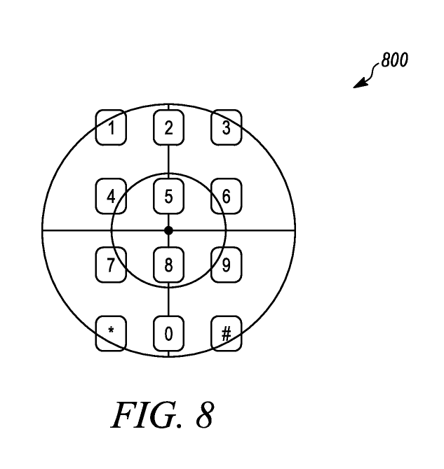

FIG. 6 is an example illustration of an x-axis 610 and y-axis 620 outputs in time graph 600 according to one embodiment. FIG. 7 is an example resultant vectors over time illustration 700 for an x-axis 720 and a y-axis 730 according to one embodiment. In a trough-type sensor layout 230, numeric and/or alphanumeric keypad layouts can be implemented and key presses can be detected. With the ratio system described above, this can be done through the definition of ratio regions for each of the key locations. A stabilization threshold can be instituted for a keypress to have the system 230 respond quickly to user inputs. There can be a very quick ramp from an equilibrium point in each the x and y orientations followed by a relatively constant hold period over the desired key region. Therefore a delay can be used to determine the final resting place of the keypress and to ignore quick transients through other map-able points. The tip of the line, such as line 710, of each location in illustration 700 can be the mapped location at a times T1-T6, for example, in the graph 600. The wait period for the actual key input can be a fixed time delay derived from user testing, or one could look at the slope of the time signal. If the slope is greater than a preset limit, then the location may not be passed along as a location. When the slope is less than a given threshold, the location can be passed along for further use by a device's software. FIG. 8 is an example illustration of this type of ratio region for a normal numeric keypad 800 according to one embodiment.

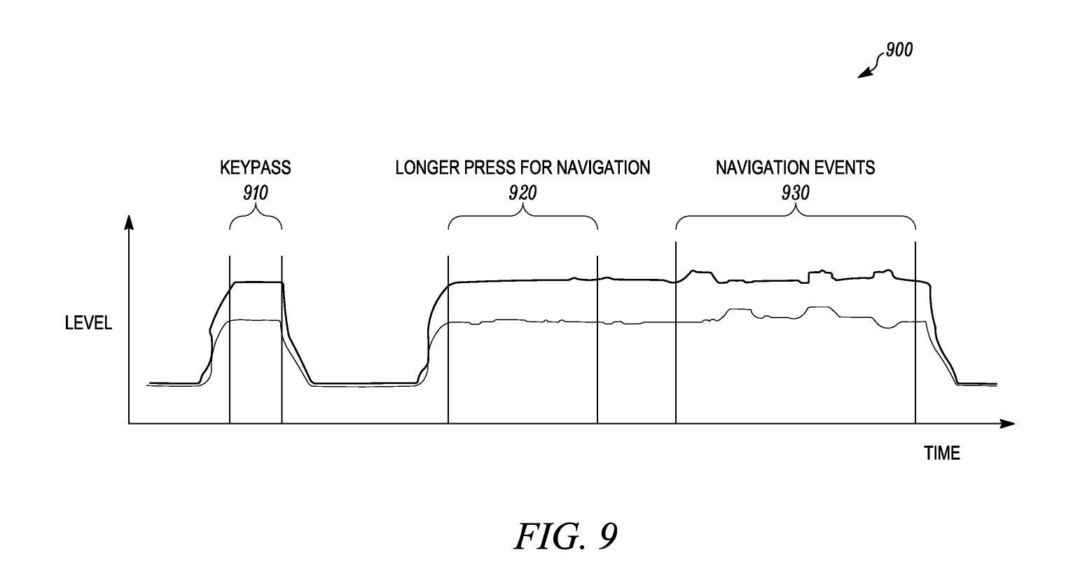

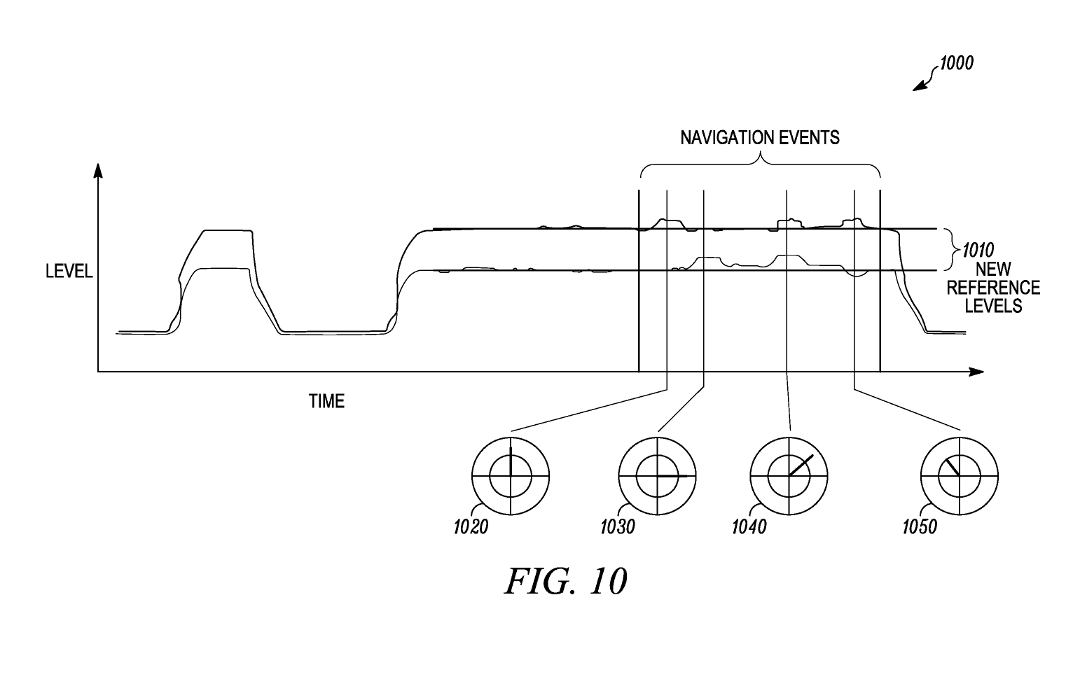

FIG. 9 is an example illustration of time response graph 900 of a keypress event followed by a longer hold, which initiates the beginning of a navigation event. The concept of using timing to distinguish between a keypress and a joystick navigation event is closely related to the concept of timing for a keypress. This process can be based on a length of a period of time, where an absolute magnitude of signal can be measured to be nonzero and stationary within certain tolerance limits. The first bracketed time frame 910 can represent an event that falls within the time limits for a keypress event. The second time frame 920 can represent a time frame that exceeds a keypress and the third time frame 930 can represent a time period where navigation information is being received by the device. This navigation period can begin after a predetermined period of time elapses which is longer than a keypress event where the signal remains non-zero and stationary. This keypress event can end when the signal returns to the original reference level for a given period of time or when the signal leaves a second wider tolerance about a new reference level. FIG. 10 is an example illustration of a graph 1000 of new reference levels 1010. A reference level can be determined to be an average level during a press-hold time used to initiate a navigation mode of operation. The new reference levels can be different from one another when the trough type of system is used. The graph 1000 can demonstrate navigation events related to an up nudge 1020, a right nudge 1030, an up-right diagonal nudge 1040 and an up-left diagonal nudge 1050. Not only can the angular reference be reset, but the magnitude can also be reset. This can allow for a virtual joystick to be created at any point on the surface and relative to any initial finger force.

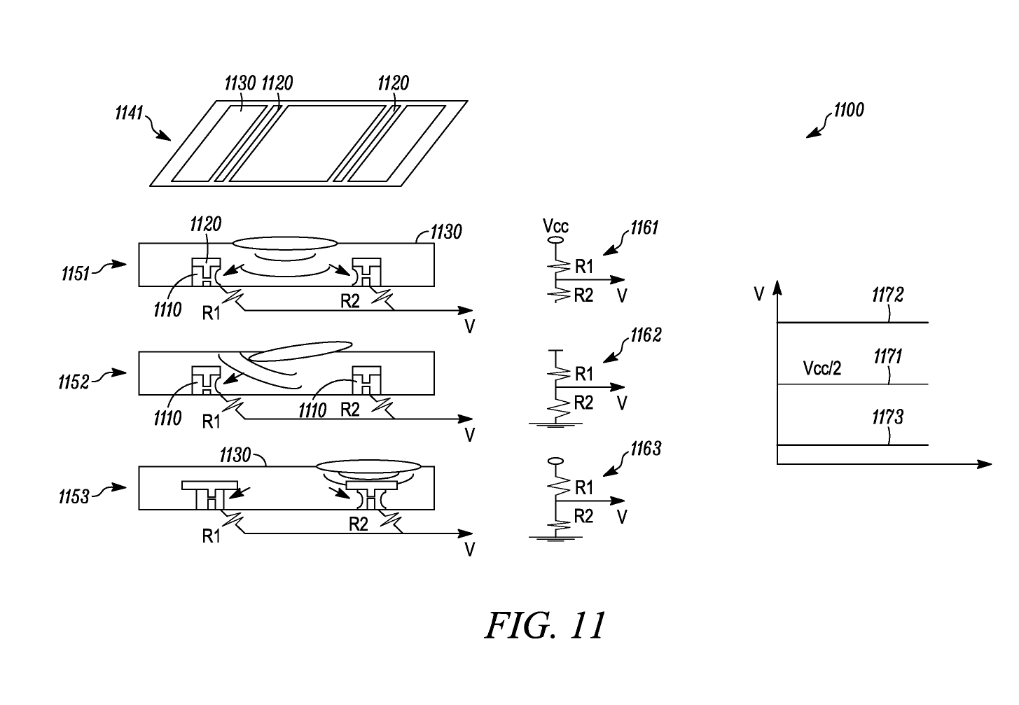

FIG. 11 is an example illustration of a system 1100 showing a relationship between finger placements according to one embodiment. The system 1100 shows a flexible elastomer touch surface 1141, corresponding structure 1151-1153 underneath the touch surface 1141, related effective equivalent circuit diagrams 1161-1163, and related outputs 1171-1173 for different finger presses, respectively. A finger can press between T-tops 1151, which can create the effective circuit 1161, and corresponding output 1171. A finger can press at an angle between T-tops 1152, which can create the effective circuit 1162, and corresponding output 1172. A finger can press on top of one T-top 1153, which can create the effective circuit 1163, and corresponding output 1173.

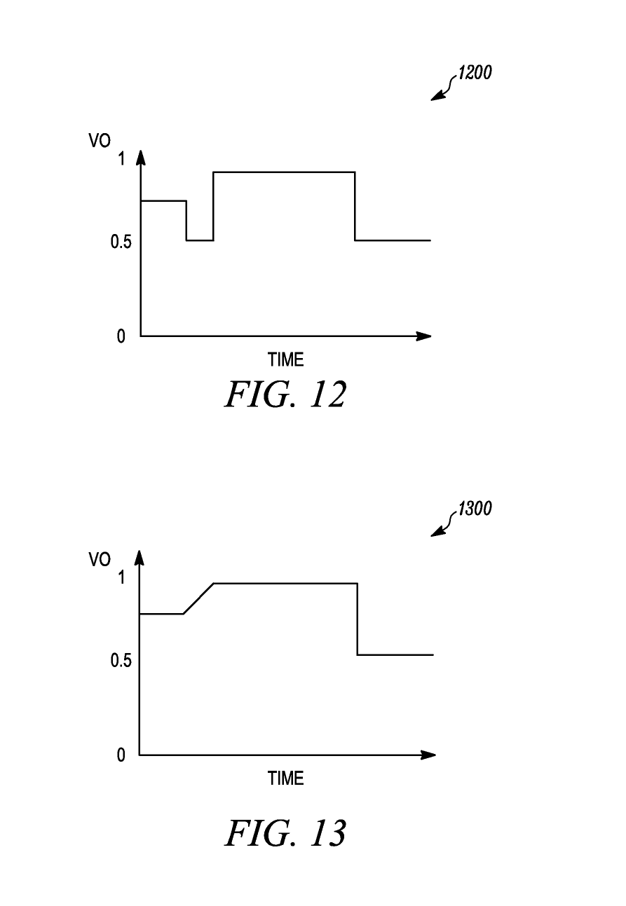

For navigation purposes the difference between a static placement of a finger and a nudge or roll can be detected via a voltage transition in the time wave form. The voltage off of the bridge can be sampled at a fixed rate in time. The collection of these samples can form the sensor dividers time wave form. FIG. 12 is an example illustration of a graph 1200 showing a difference in the time signal between pressing at a point roughly equidistant between sensors according to one embodiment. FIG. 13 is an example illustration of a graph 1300 showing the time signal for pressing at a point near one sensor, and nudging or rolling between the two points. The graph 1200 shows discrete touches at the two points, while the graph 1300 shows the nudge or roll gesture.

Under a finger press, a flexible skin region covering the sensors can deform, causing detectable changes at the internal sensing surfaces. This change can be sensed via a multiplicity of embedded sensors integrated on top of pyramid structures such as Force Sensitive Resistor (FSR) sensors, piezoelectric sensors, capacitive sensors, and other sensing technologies. One embodiment can use vertical walls with sensors placed along the vertical walls surfaces. Another embodiment can use pyramid walls with oblique surface angles. Yet another embodiment can use any other structure for mounting sensors such as curved, Saw tooth, spherical, etc.

The system 1100 shows a vertical T-wall structure according to one embodiment. The system 1100 can use FSR materials 1110 placed along vertical surface walls of T-wall structures 1120 and covered with a rubbery like material 1130 that can deform under finger pressure. This vertical wall structure 1120 can be used to convey a point that, with the rubber material 1130, the sensor can be placed vertical to a touch screen, and still detect a vertical press.

For example, the system 1100 can show the impact of the rubber 1130 deformation caused by finger presses on the vertical sensors 1151-1153, which in turns impacts the equivalent resistive ladder 1161-1163 generating distinct voltage outputs 1171-1173, respectively. When a user presses a central area between two T-walls 1151, both FSR equivalent resistors can decrease, which can result in an unchanged net effect if the press impacts the sensors equally. As the finger squeezes in a biased direction 1152 toward one of the T-walls sensitive surfaces 1110, the rubber skin 1130 can deform in a way that can act that sensor in a way more severe causing the output voltage to increase as shown in 1172. When the user places a finger on top 1153 of the T-wall, both sides of the wall are impacted roughly equally, causing the output voltage 1173, which can indicate a press above a key, which can be used for a dialing application. As another example, the sensor 1110 can be acted on in the location of 1153 with an angled finger press for directional control of a finger press via rubber deforming without finger sliding.

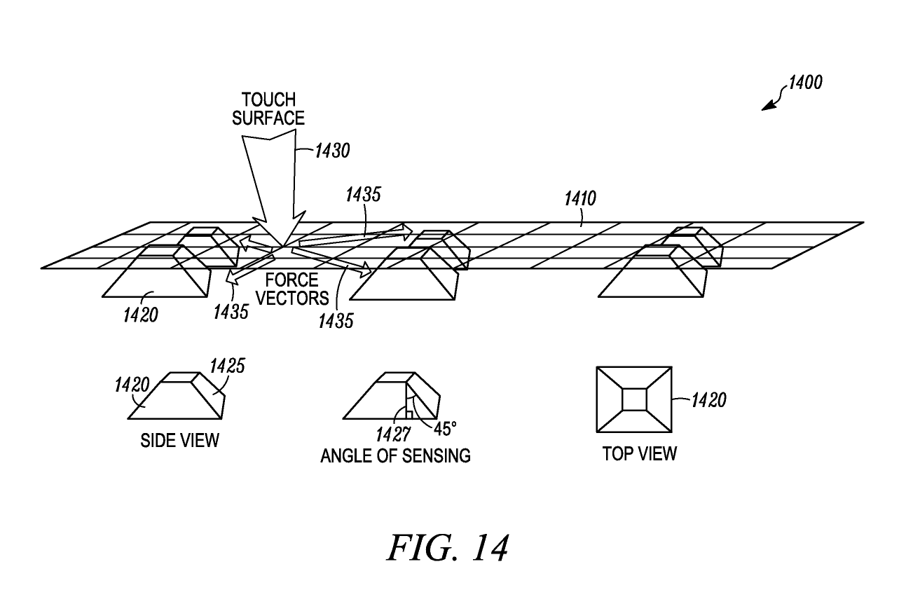

FIG. 14 is an example illustration of system 1400 having trapezoidal sensor components 1420 beneath a touch surface 1410 according to one embodiment. The trapezoidal sensor components 1420 can be a pyramid-type structure with oblique surfaces 1425, such as inclined surfaces. The inclined surfaces 1425 can be more sensitive to the user press or nudge as the nudge can contain vertical and horizontal component vectors 1435 covered by a rubber overlay touch surface 1410. This implementation can enable a user to press anywhere on the rubber material 1410 for dialing application or directional control, such as zoom, volume, navigation, gallery, or other controls, without sliding the user's finger on top of the rubber skin 1410. The rubber material 1410 can also serve a dual purpose as a water seal and drop protection cover for the keypad sensors 1420 underneath and other hardware inside the device. The elastomeric material can also serve the function to improve grip and can give some users a touch comfort interface while using the device.

For example, three dimensional sensing components 1420 with multiple sensing surfaces or faces can be embedded beneath the touch sensitive surface 1410 and used to indicate the location of the touch on that surface 1410. These three dimensional sensors 1420 can be embedded within a material that uniformly transfers force in all directions 1435 from the point of contact. The sensors 1420 can be constructed as trapezoidal components with multiple sensing faces 1425. Embodiments can be derived that position the sensor faces 1425 at angles from 0 to 90 degrees from perpendicular 1427 to the touch surface 1410. The angle of the sensing face 1425 to the perpendicular 1427 or conversely to the touch surface 1410 can be optimized for reception of the touch force 1430 depending upon multiple factors including the material properties of the medium, the depth of the sensors 1420, and the angle and depiction of the touch screen 1410. Sensing surfaces 1425 can be utilized on one to six surfaces of a trapezoidal structure or on each separate face of shapes other than trapezoids.

One embodiment utilizes trapezoidal sensor components 1420 with sensing surfaces 1425 on four sides. A fifth sensor can also be placed on the top side of the pyramid sensor 1420 if desired. Each side 1425 can make a 45 degree angle or other angle with the perpendicular 1427. Each sensor surface 1425 can indicate a force level that is commeasurable to the distance from the sensor 1420 to the location of the touch disturbance on the touch surface 1410.

Finger location and press direction can be deduced by assessing the relative sensor outputs within each pyramid structure 1420 as well as between different pyramid structures 1420, such as between three pyramid structures 1420. Embodiments of embedded sensors can also be used to determine the direction of finger press rubber deformation. For example, after the location of the initial touch is located by comparison of the force strength on three or more sensor surfaces 1425, the integration of subsequent locations of the force over time can indicate the direction movement and can be used to define increasing or decreasing commands such as volume control, accelerating or steering an object, setting backlight brightness, or other commands.

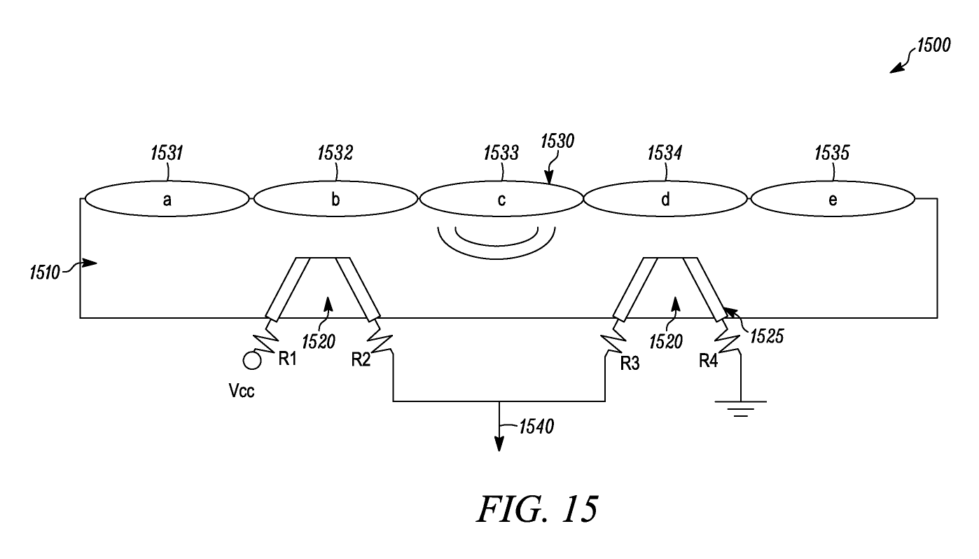

FIG. 15 is an example illustration of a pyramid structure system 1500 using FSR type resistive sensors 1525 on pyramid structures 1520 forming a ladder voltage network. A user can press 1530 a finger or a stylus at various locations 1531, 1532, 1533, 1534, and 1535 on top of a rubber skin cover 1510. The press location can impact the FSR equivalent resistances R1-R4 in the various pyramid structures based on the finger location and an output 1540 can be generated based on the resistances' change. The location of the press 1530 can then be determined by the voltage level at the output 1540. A higher VCC, such as 3V in one example, can provide a good sensor spread relative to finger press location, but other voltages can be used. The topology the system of 1500 can be used as a keypad when a finger press is on top of pyramids 1520 corresponding to keys, resulting in rail-to-rail voltage levels and can be used for directional commands when the finger press is on top or between the pyramids 1520 or when a finger press shows a nudge in a direction over a given period of time. Different circuit networks can be used with different electrical components that may result in different detected outputs 1540 to determine where and how a user presses 1530 the rubber skin cover 1510.

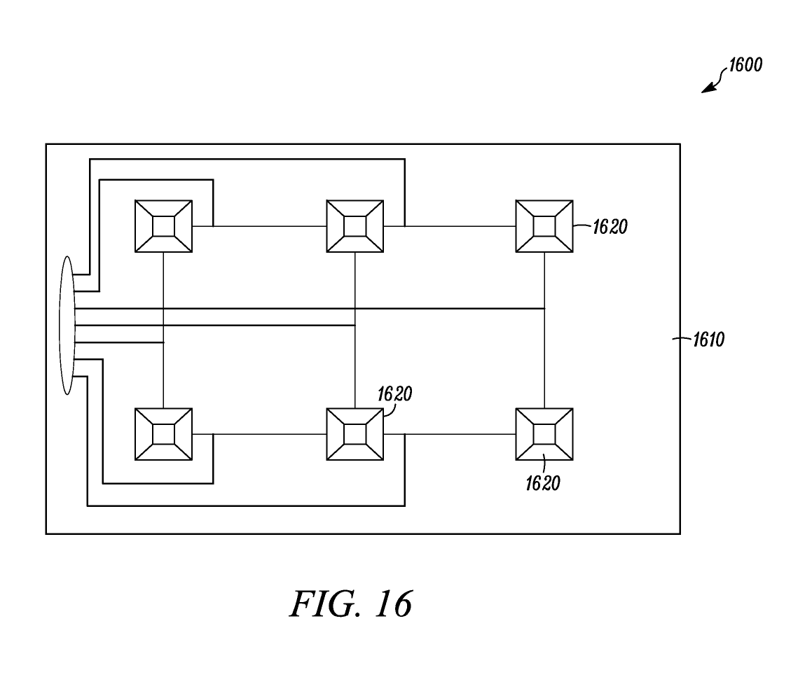

FIG. 16 is an example illustration of pyramid interconnection scheme 1600 according to a possible embodiment. The pyramid interconnection scheme 1600 can be used to determine press location on a rubber or other deformable surface 1610 by looking at the relative impact of a press on multiple pyramid structures 1620, which can be similar, but not limited to, the triangulation concept. Rail-rail top or bottom voltages when finger is on pyramid structure 1620 can be a detectable parameter. The pyramid structure sizes vary dependent on the device and can cover any range and size that can be accommodated by the sensor technologies.

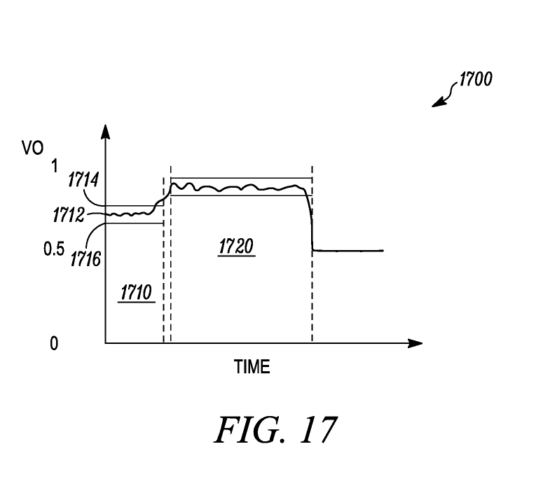

FIG. 17 is an example illustration of a graph 1700 of a voltage output of a network using orthogonal sensors. A region 1710 can have trigger level center 1712 set at the initial touch point. An adaptive trigger level can be used for adaptive triggering to account for natural shake in the user's finger. The trigger level center 1712 can be selected as an initial voltage. An upper 1714 and lower 1716 trigger level can be a percentage above and below the trigger level center voltage 1712. When a user nudges their finger closer to another sensor, the voltage time signal can exceed the trigger level and begin a transition period to another region 1720. The transition period can last until the slope of the time averaged signal changes significantly. New trigger levels can then be set for the new region 1720.

Embodiments should not be limited to capacitive and FSR sensors only. Embodiments can be implemented with stacked piezoelectric sensors, capacitive sensors, FSR sensors, etc. Piezoelectric sensors can be implemented as a stack against a solid backer, or a bender mounted as a beam over a shallow depression in a backing surface. Capacitive sensors can consist of a base layer and upper layer separated by a flexibile/compressible insulator region, which is then covered by an elastomeric touch surface, or as a traditional capacitive sensor where the user completes the circuit.

Embodiments can provide for an apparatus that can include an apparatus housing, a substantially planar touch surface coupled to the apparatus housing, and a plurality of oblique sensors coupled to the touch surface. Each oblique sensor of the plurality of oblique sensors can have a sensor surface substantially oblique to the touch surface. The plurality of oblique sensors can detect a touch force parallel to the touch surface.

The apparatus can include a controller coupled to the plurality of oblique sensors. The controller can determine a contact force based on forces on the plurality of oblique sensors. The controller can determine a contact force based on a ratio of forces on the plurality of oblique sensors. The controller can determine a planar force component of the contact force based on a ratio of forces on the plurality of oblique sensors and a normal force on the touch surface, where the planar force can be parallel to the touch surface. The controller can determine a normal force component of the contact force based on a combination of forces on the plurality of oblique sensors and a normal force on the touch surface, the normal force being normal to the touch surface. For example, a combination of forces can be a sum, can be based on an equation that can give a common component of the oblique sensors, can be a selection of the forces, or can be any other combination. The controller can determine a planar force component of the contact force based on a difference between forces on the plurality of oblique sensors.

Each oblique sensor can have a sensor surface substantially non-parallel and non-orthogonal to the touch surface. Each oblique sensor can output a sensor signal in response to a user input. The controller can receive the sensor signals and can determine vector components of the user input, where the vector components can lie in an axis normal to the touch surface and parallel to the touch surface. The controller can translate a force vector applied to a substantially constant position on the touch surface into a sensed vector direction.

The plurality of oblique sensors can include a first oblique sensor having a first oblique sensor surface substantially non-parallel to the touch surface facing in a first direction and a second oblique sensor having a second oblique sensor surface substantially non-parallel to the touch surface facing in a second direction perpendicular to the first direction. The plurality of oblique sensors can include a first oblique sensor having a first oblique sensor surface substantially non-parallel to the touch surface facing in a first direction and a second oblique sensor having a second oblique sensor surface substantially non-parallel to the touch surface facing in a second direction with a portion of a projection parallel to the touch surface substantially opposite to the first direction. The plurality of oblique sensors can be configured to sense a force on the touch surface perpendicular to the touch surface and a force on the touch surface parallel to the touch surface.

The touch surface can be a deformable touch surface. For example, the touch surface can be deformable by bending or compression. The touch surface can be a rigid surface suspendably coupled to the apparatus housing. For example, the touch surface can be suspended within the apparatus housing gaskets, rubber mountings, or other flexible materials.

An oblique sensor can be a piezoelectric sensor, a capacitive sensor, a resistive sensor, or any other sensor. For example, an oblique sensor can be a piezoelectric sensor having one of a bendable piezoelectric stack and a compressible piezoelectric stack. As another example, an oblique sensor can have a first capacitive plate, a second capacitive plate, and a compressible elastomeric dielectric material positioned between the first capacitive plate and the second capacitive plate.

Embodiments can provide a touch and nudge interface on a surface without having to create an entire grid of sensors in the device as is done with typical capacitive or resistive arrays. Embodiments can also detect a lateral compression in a material that would accompany a finger nudge, which can be a desirable feature that a typical sensor array cannot resolve. Embodiments can also detect directional finger squeeze/press without finger sliding, such as when finger presses against/deforms rubber skin, which can be a new experience.

The methods of this disclosure may be implemented on a programmed processor. However, the operations of the embodiments may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the operations of the embodiments may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The term “coupled,” unless otherwise modified, implies that elements may be connected together, but does not require a direct connection. For example, elements may be connected through one or more intervening elements. Furthermore, two elements may be coupled by using physical connections between the elements, by using electrical signals between the elements, by using radio frequency signals between the elements, by using optical signals between the elements, by providing functional interaction between the elements, or by otherwise relating two elements together. Also, relational terms, such as “top,” “bottom,” “front,” “back,” “horizontal,” “vertical,” and the like may be used solely to distinguish a spatial orientation of elements relative to each other and without necessarily implying a spatial orientation relative to any other physical coordinate system. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. An apparatus comprising:
an apparatus housing;
a substantially planar touch surface coupled to the apparatus housing; and
a plurality of oblique sensors coupled to the touch surface, each oblique sensor of the plurality of oblique sensors having a sensor surface substantially oblique to the touch surface, the plurality of oblique sensors configured to detect a touch force parallel to the touch surface.

2. The apparatus according to claim 1, further comprising a controller coupled to the plurality of oblique sensors, the controller configured to determine a contact force based on forces on the plurality of oblique sensors.

3. The apparatus according to claim 1, further comprising a controller coupled to the plurality of oblique sensors, the controller configured to determine a contact force based on a ratio of forces on the plurality of oblique sensors.

4. The apparatus according to claim 2, wherein the controller is configured to determine a planar force component of the contact force based on a ratio of forces on the plurality of oblique sensors and a normal force on the touch surface, the planar force being parallel to the touch surface.

5. The apparatus according to claim 2, wherein the controller is configured to determine a normal force component of the contact force based on a combination of forces on the plurality of oblique sensors and a normal force on the touch surface, the normal force being normal to the touch surface.

6. The apparatus according to claim 2, wherein the controller is configured to determine a planar force component of the contact force based on a difference between forces on the plurality of oblique sensors.

7. The apparatus according to claim 2,
wherein each oblique sensor has a sensor surface substantially non-parallel and non-orthogonal to the touch surface,
wherein each oblique sensor outputs a sensor signal in response to a user input, and
wherein the controller receives the sensor signals and determines vector components of the user input, the vector components lying in an axis normal to the touch surface and parallel to the touch surface.

8. The apparatus according to claim 2, wherein the controller is configured to translate a force vector applied to a substantially constant position on the touch surface into a sensed vector direction.

9. The apparatus according to claim 1, wherein the plurality of oblique sensors comprises a first oblique sensor having a first oblique sensor surface substantially non-parallel to the touch surface facing in a first direction and a second oblique sensor having a second oblique sensor surface substantially non-parallel to the touch surface facing in a second direction perpendicular to the first direction.

10. The apparatus according to claim 1, wherein the plurality of oblique sensors comprises a first oblique sensor having a first oblique sensor surface substantially non-parallel to the touch surface facing in a first direction and a second oblique sensor having a second oblique sensor surface substantially non-parallel to the touch surface facing in a second direction with a portion of a projection parallel to the touch surface substantially opposite to the first direction.

11. The apparatus according to claim 1, wherein the plurality of oblique sensors are configured to sense a force on the touch surface perpendicular to the touch surface and a force on the touch surface parallel to the touch surface.

12. The apparatus according to claim 1, wherein the touch surface comprises a deformable touch surface.

13. The apparatus according to claim 1, wherein the touch surface comprises a rigid surface suspendably coupled to the apparatus housing.

14. The apparatus according to claim 1, wherein an oblique sensor comprises one of a piezoelectric sensor, a capacitive sensor, and a resistive sensor.

15. The apparatus according to claim 1, wherein an oblique sensor comprises a piezoelectric sensor having one of a bendable piezoelectric stack and a compressible piezoelectric stack.

16. The apparatus according to claim 1, wherein an oblique sensor comprises a first capacitive plate, a second capacitive plate, and a compressible elastomeric dielectric material positioned between the first capacitive plate and the second capacitive plate.

17. The apparatus according to claim 1, wherein an oblique sensor comprises one of a force sensor, a displacement sensor, and a velocity sensor
